(19) United States
(12) Patent Application Publication
(10) Pub. No.: US 2021/0058853 A1
(43) Pub. Date: Feb. 25, 2021

(54) PROVISION OF AVAILABLE SERVICE INFORMATION FOR A NETWORK PRIOR TO A NETWORK CONNECTION

(71) Applicant: ARRIS Enterprises LLC, Suwanee, GA (US)

(72) Inventors: Subash Tirupachur Comerica, Sunnyvale, CA (US); Wenge Ren, Fremont, CA (US)

(21) Appl. No.: 16/996,415

(22) Filed: Aug. 18, 2020

Related U.S. Application Data
(60) Provisional application No. 62/891,008, filed on Aug. 23, 2019.

(51) Int. Cl. H04W 48/14; H04W 48/16

(52) U.S. Cl. CPC H04W 48/14; H04W 48/16

(57) ABSTRACT

Aspects of the present disclosure describe technologies for providing and receiving available service information for a network, prior to a connection to the network via an access point. An access point determines a list of available services on a network associated with the access point. The list of available services is stored in a memory of the access point. The access point provides the list of available services to an endpoint device in a vendor specific information element prior to an establishment of a wireless connection between the access point and the endpoint device.

### CROSS-REFERENCE TO RELATED APPLICATION

The present application claims priority to U.S. Provisional Patent Application No. 62/891,008, filed Aug. 23, 2019, the entire content of which is incorporated herein by reference as if set forth fully herein.

### FIELD

The described embodiments relate to techniques for providing and receiving information on available services in a network.

### BACKGROUND

This section discusses related art, which may or may not be prior art, to provide background information with the intention to facilitate a better understanding of various technologies described herein. Accordingly, it should be understood that the statements in this section are not to be read as admissions of prior art.

Many electronic devices are capable of wirelessly communicating with other electronic devices. For example, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Wash.), and/or another type of wireless network. In a WLAN based on an IEEE 802.11 standard, one or more electronic devices (which are sometimes referred to as stations, client devices, endpoints, or endpoint devices) discover, associate with and communicate with one or more access points.

Service discovery on a network involves an endpoint device determining available services on a network from an access point of the network. Currently, an endpoint can only determine the available services of a particular network after the endpoint has been fully connected to the network, i.e., fully associated and authenticated. In many cases, an endpoint device connects to a network only to determine that the network to which the endpoint device has connected does not offer the services desired by the endpoint device.

### SUMMARY

A first group of described embodiments relates to implementations of various aspects of a method for providing available service information prior to initiating a network connection. An access point determines a list of available services on a network associated with the access point. The list of available services is stored in a memory of the access point. The access point provides the list of available services to an endpoint device in a vendor specific information element prior to an establishment of a wireless connection between the access point and the endpoint device.

In an embodiment, the list of available services may be configurable. In another embodiment, the list of available services may be determined using a discovery protocol. In further embodiments, the list of available services may be periodically refreshed. In still further embodiments, the list of available services may be provided in the vendor specific information element of a beacon. In certain embodiments, one or more of the list of available services can be provided in the vendor specific information element of a probe response from the access point to the endpoint device. The probe response provided may, in some embodiments, be in response to a probe request from the endpoint device.

A second group of described embodiments relates to implementations of various technologies of a method for providing available service information prior to initiating a network connection. The access point caches available service information from an advertisement server. The access point provides the cached available service information to an endpoint device prior to an establishment of a wireless connection between the access point and the endpoint device.

In an embodiment, the cached available service information can be periodically refreshed. In some embodiments, the cached available service information may be determined over a predetermined time period. In further embodiments, the cached available service information may be determined from a plurality of Generic Advertisement Service (GAS) requests and a plurality of GAS responses between the access point and the endpoint device. In still further embodiments, the cached available service information may further be determined from a plurality of query requests and query responses between the access point and the advertisement server. Each of the GAS requests, GAS responses, query requests and query responses, in certain embodiments, can include or use Access Network Query Protocol (ANQP) elements.

In some embodiments, providing cached available service information can provide network optimization by reducing an amount of query requests and query responses between the access point and the advertisement server. The cached available service information can, in certain embodiments, be provided in a GAS response to the endpoint device. In such an implementation, the GAS response can be provided in response to a GAS request received by the access point from the endpoint device. In a further implementation, the GAS response includes ANQP elements requested by the endpoint device.

A third group of described embodiments relates to implementations of various technologies of a method for determining available service information prior to initiating a network connection. An endpoint configured to handle vendor specific information elements detects an access point of a wireless network. The endpoint determines available service information from a vendor specific information element received from the access point prior to an establishment of a wireless connection between the access point and the endpoint device.

In an embodiment, the endpoint may receive the available service information in the vendor specific information element of a beacon from the access point. In a further embodiment, the endpoint can send a probe request to the access point. In a still further embodiment, in response to the sent probe request, the endpoint can receive a probe response from the access point including the available service information in the vendor specific information element of the probe response.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following detailed description, figures, and claims.

### BRIEF DESCRIPTION OF THE DRAWING

FIG. 1 illustrates an example of a network environment in accordance with an embodiment.

FIG. 2 illustrates a flow diagram of a method for providing available service information prior to initiating a network connection in accordance with an embodiment.

FIG. 3 illustrates an example network environment in accordance with an embodiment.

FIG. 4 illustrates a flow diagram of a method for providing available service information prior to initiating a network connection in accordance with an embodiment.

FIG. 5 illustrates a flow diagram of a method for determining available service information prior to initiating a network connection in accordance with an embodiment.

FIG. 6 illustrates a schematic diagram of an example of a computing system in which the various embodiments and technologies described herein may be deployed or incorporated.

Note that like reference numerals refer to corresponding parts throughout the drawings. Moreover, multiple instances of the same part are designated by a common prefix separated from an instance number by a dash.

### DETAILED DESCRIPTION

In the discussion that follows, electronic devices or components in a system communicate packets in accordance with a wireless communication protocol, such as: a wireless communication protocol that is compatible with an IEEE 802.11 standard (which is sometimes referred to as “Wi-Fi®,” from the Wi-Fi Alliance of Austin, Tex.), Bluetooth® (from the Bluetooth Special Interest Group of Kirkland, Wash.), and/or another type of wireless interface (such as another wireless-local-area-network interface). Moreover, an access point in the system may communicate with a controller or services using a wired communication protocol, such as a wired communication protocol that is compatible with an Institute of Electrical and Electronics Engineers (IEEE) 802.3 standard (which is sometimes referred to as “Ethernet”), e.g., an Ethernet II standard. However, a wide variety of communication protocols may be used in the system, including wired and/or wireless communication. In the discussion that follows, Ethernet and Wi-Fi are used as illustrative examples.

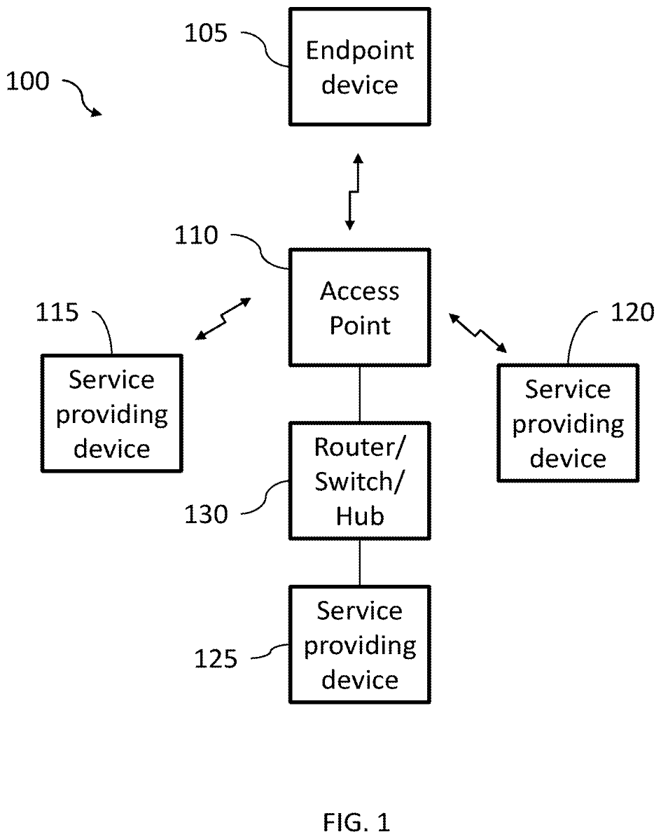

One or more implementations of various techniques for providing and/or determining available service information prior to initiating a network connection will now be described in more detail with reference to FIGS. 1-6 in the following paragraphs.

FIG. 1 is a block diagram illustrating an example network environment 100 for providing available service information prior to initiating a network connection. Network 100 includes an endpoint device 105, and access point 110, service devices 115, 120, 125, and router, switch or hub 130. Access point 110 provides a wireless local area network (WLAN). The access point 110 may be coupled to a wired router, switch or hub 130 via an Ethernet cable and project a Wi-Fi signal to a particular area. Services may be provided by service devices 115, 120 directly through the access point 110 or in the case of service providing device 125, through router/switch/hub 130.

In Wi-Fi compatible networks, access points periodically send beacons. Beacons are used by the access point to advertise the presence of the access point to endpoint devices and include the service set identifier (SSID) of the access point. Beacons are usually sent by particular access points at periodic intervals. In addition, at times, end points perform active scanning by sending probe requests to particular access points or to any access point within a proximity of the endpoint device. The probe request is a request, by the endpoint device, for information from one or more access points. In response to the probe request, the access point(s) send a probe response, which includes similar information to the information sent in a beacon.

Access point 110 may determine a list of available services on network 100 using a discovery protocol. The discovery protocol may be Link-Layer Discovery Protocol (LLDP), Cisco® Discovery Protocol (CDP), Bonjour®, or any other discovery protocol capable of determining the services available on network 100. Access point 110 may store the list of available services in a memory of the access point 110. The list of available services may be provided by the access point 110 to the endpoint device 105 prior to an establishment of a wireless connection between the access point 110 and the endpoint device 105.

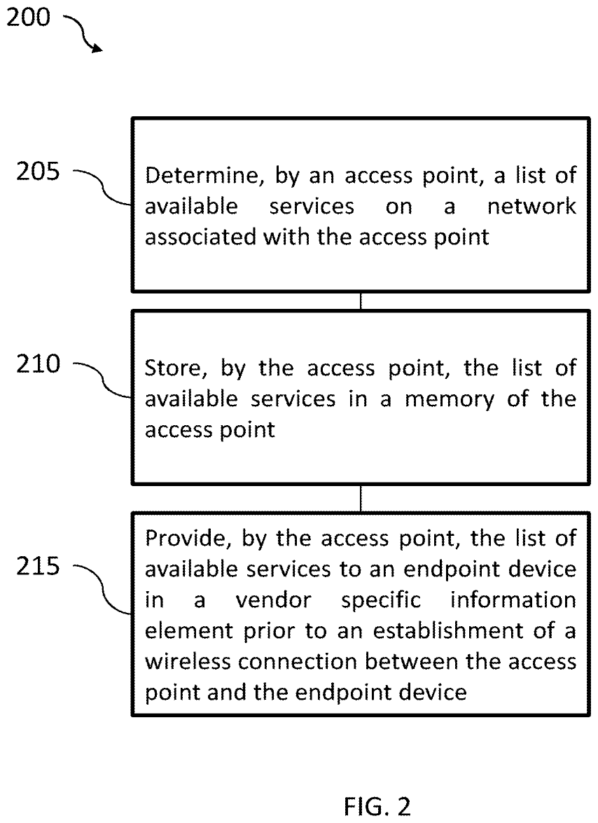

FIG. 2 illustrates a diagram of a method 200 for providing available service information prior to initiating a network connection. At block 205, an access point, e.g., access point 110, determines a list of available services on a network, e.g., network 100, associated with the access point. The list of available services is configurable and/or determined by using a discovery protocol, e.g., LLDP, CDP, Bonjour or any other acceptable discovery protocol. The list of services may include, but are not limited to, printing services, audio and/or video services, surveillance camera(s), mobile to mobile services, and available storage device(s). The access point, using the discovery protocol, learns information about the services available on the network.

At block 210, the list of available services is stored in a memory of the access point. In one implementation, the list of available services can be periodically updated or refreshed, e.g., to reflect that a previously available service is no longer provided or available on the network.

At block 215, the access point provides the list of available services to an endpoint device in a vendor specific information element prior to an establishment of a wireless connection between the access point and the endpoint device. In one implementation, the list of available services is provided by the access point to the endpoint in a beacon. In this implementation, the list of available services is provided in the vendor specific information element of the beacon. In one implementation, in response to a probe request from the endpoint device, the access point provides the list of available services to the endpoint device in a probe response. In this implementation, one or more of the list of available services is provided in the vendor specific information element of the probe response. In one implementation, the vendor specific information element may be implemented in accordance with IEEE 802.11, section 7.3.2.26.

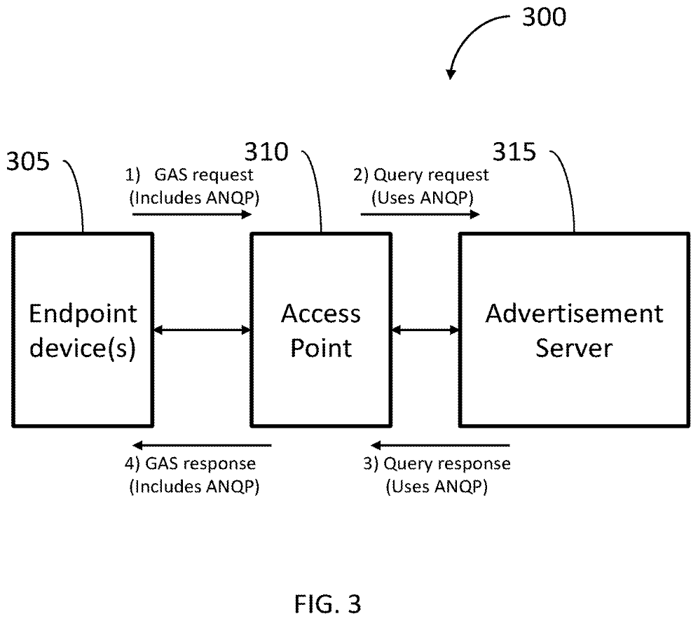

FIG. 3 is a block diagram illustrating an example network environment 300 for providing available service information prior to initiating a network connection. The devices of network 300 may be configured to be part of an IEEE 802.11 compliant wireless Local Area Network (WLAN). In particular network 300 may include features supported by IEEE 802.11u. Network 300 includes one or more endpoint devices 305, an access point 310 and an advertisement server 315. IEEE 802.11u compliant devices support the Generic Advertisement Service (GAS) framework. The GAS framework provides transport for advertisement services that include, but are not limited to, the Access Network Query Protocol (ANQP). The ANQP is used to discover network information. A client, e.g., endpoint device 305, uses an advertisement protocol, e.g., ANQP, to query the access point 310 using GAS. An endpoint device 305 may send a GAS request to the access point 310. The GAS request provides a list of ANQP elements that the endpoint device 305 wants to receive from the access point 310. In turn the access point 310 may send a query request (using ANQP) to the advertisement server 315. Advertisement server may then send a query response (using ANQP) to the access point 310. The access point 310 may then send a GAS response (including the ANQP elements requested by endpoint device 305) to the endpoint device 305.

Access point 310 can provide a network optimization that communicates available service information directly from the access point and reduces a number of query requests/responses to/from the advertisement server 315. This network optimization is accomplished by caching available service information provided in previous GAS responses that were sent from the access point in response to previous GAS requests from endpoint devices. The cache of available service information is formed at the access point 310 by receiving GAS requests and providing GAS responses over time (and receiving query responses from the advertisement server 315 over time in response to query requests sent from the access point 310 to the advertisement server 315). In response to future GAS requests from endpoint device(s) 305, the access point 310 can provide some or all of the cached available service information in a GAS response. Providing cached available service information optimizes the network by reducing an amount of query requests and query responses between the access point 310 and the advertisement server 315.

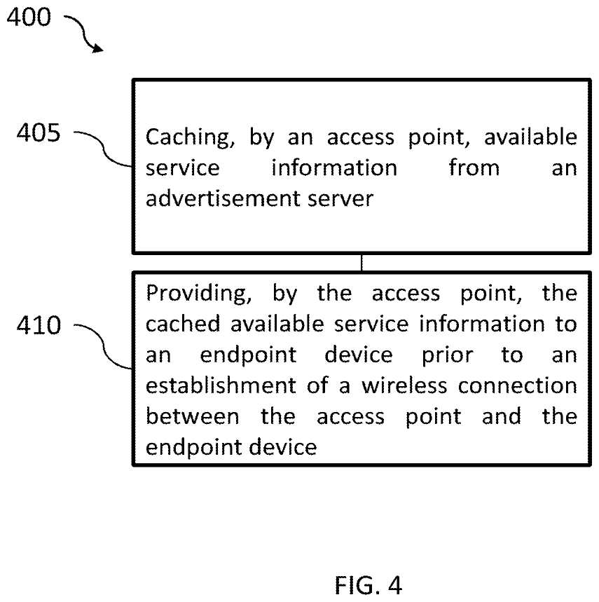

FIG. 4 illustrates a diagram of a method 400 for providing available service information prior to initiating a network connection. At block 405, an access point, e.g., access point 310, caches available service information from an advertisement server, e.g., advertisement server 315.

The cached available service information can be determined from a plurality of GAS requests and a plurality of GAS responses between the access point 310 and the endpoint device 305. As described in FIG. 3, in an 802.11u compliant network, prior to implementation of the cache of available service information, there is a corresponding query request and query response between the access point 310 and the advertisement server 315 for each GAS request and GAS response between the access point 310 and the endpoint device 305. Each of the requests (GAS, query) and responses (GAS, query) includes or uses ANQP elements or information.

The cached available service information may include information determined over a predetermined time period from GAS requests and GAS responses and/or determined from a predetermined number of GAS requests and GAS responses. In one implementation, the cached available service information can be periodically updated or refreshed, e.g., to reflect that a previously available service is no longer provided or available on the network. Once the cache of available service information has been determined, the access point 305 can provide a GAS response in response to a GAS request from the endpoint device, directly from the access point 310, i.e., without sending a query request to the advertisement server 315 and receiving a query response from the advertisement server 315.

At block 410, the access point provides the cached available service information to an endpoint device, e.g., endpoint device 305, prior to an establishment of a wireless connection between the access point and the endpoint device. In one implementation, providing cached available service information provides network optimization by reducing or minimizing an amount of query requests and query responses between the access point 310 and the advertisement server 315.

In one implementation, some or all of the cached available service information can be provided in a GAS response to the endpoint device. The GAS response can be provided in response to a Generic Advertisement Service request received by the access point from the endpoint device. The GAS response may include ANQP elements requested by the endpoint device.

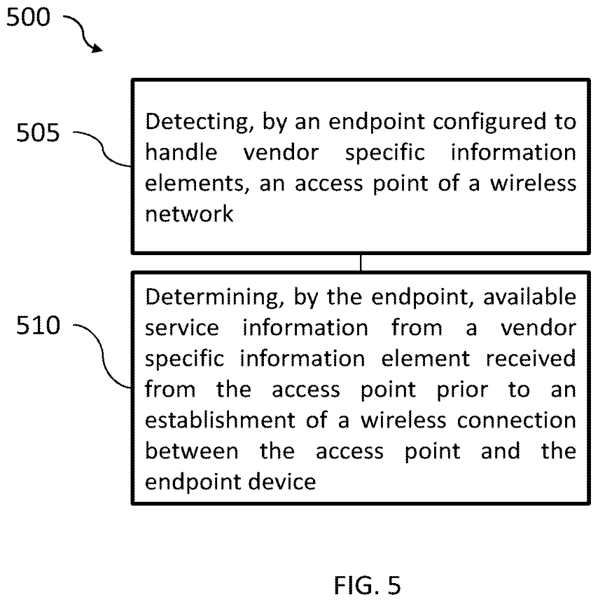

FIG. 5 illustrates a diagram of a method 500 for determining available service information prior to initiating a network connection. At block 505, an endpoint, e.g., endpoint device 105, configured to handle vendor specific information elements detects an access point of a wireless network. At block 510, the endpoint determines available service information from vendor specific information elements received from the access point prior to an establishment of a wireless connection between the access point and the endpoint device.

In one implementation, the endpoint receives the available service information in the vendor specific information element of a beacon from the access point.

In one implementation, the endpoint sends a probe request to the access point. In this implementation, in response to the sent probe request, the endpoint receives a probe response from the access point that includes some or all of the available service information, responsively to the probe request, in the vendor specific information element of the probe response.

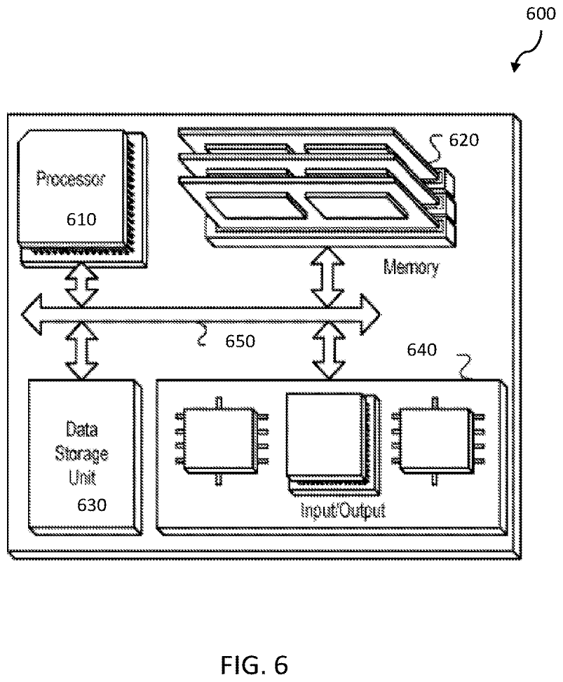

FIG. 6 is a block diagram of a hardware configuration 600 operable to provide and/or determine available service information prior to initiating a network connection, e.g., the devices present in networks 100, 300. The hardware configuration 600 can include a processor 610, a memory 620, a storage device 630, and an input/output device 640. Each of the components 610, 620, 630, and 640 can, for example, be interconnected using a system bus 650. The processor 610 can be capable of processing instructions for execution within the hardware configuration 600. In one implementation, the processor 610 can be a single-threaded processor. In another implementation, the processor 610 can be a multi-threaded processor. The processor 610 can be capable of processing instructions stored in the memory 620 or on the storage device 630.

The memory 620 can store information within the hardware configuration 600. In one implementation, the memory 620 can be a computer-readable medium. In one implementation, the memory 620 can be a volatile memory unit. In another implementation, the memory 620 can be a non-volatile memory unit. The memory 620 can also be a cache memory operating as an auxiliary memory from which high-speed retrieval of information is possible.

In some implementations, the storage device 630 can be capable of providing mass storage for the hardware configuration 600. In one implementation, the storage device 630 can be a computer-readable medium. In various different implementations, the storage device 630 can, for example, include a hard disk device/drive, an optical disk device, flash memory or some other large capacity storage device. In other implementations, the storage device 630 can be a device external to the hardware configuration 600.

The input/output device 640 provides input/output operations for the hardware configuration 600. In one implementation, the input/output device 640 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for outputting video, voice, and/or data services to a display device (e.g., television 110 of FIG. 1, mobile device, tablet, computer, etc.). In implementations, the input/output device can include driver devices configured to send communications to, and receive communications from one or more networks (e.g., network 100, network 300, etc.) and/or one or more devices within networks 100, 300.

The devices of networks 100, 300 may be configured to be part of an IEEE 802.11 compliant wireless Local Area Network (WLAN). The devices of networks 100, 300 may be configured to support features of 802.11u and Hotspot 2.0 frameworks. Networks 100, 300 may also be configured to support Internet of Things (IoT) clients. In addition, networks 100, 300 may utilize indoor positioning systems, e.g., to determine a location of particular services within a building.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

That which is claimed is:

1. A method for an access point to provide a list of available services on a wireless network to an endpoint device, the method comprising:
determining, by the access point, the list of available services on the wireless network;
storing the list of available services in a memory of the access point; and
providing, by the access point, one or more of the list of available services to the endpoint device in a vendor specific information element of a wireless communication from the access point to the endpoint device, prior to an establishment by the access point of a wireless connection of the endpoint device to the wireless network.

2. The method of claim 1, wherein the list of available services is configurable.

3. The method of claim 1, wherein determining, by the access point, the list of available services on the wireless network comprises using a discovery protocol to determine the list of available services on the wireless network.

4. The method of claim 1, further comprising periodically refreshing the list of available services stored in the memory of the access point.

5. The method of claim 1, wherein the wireless communication from the access point to the endpoint device comprises a beacon.

6. The method of claim 1, further comprising wirelessly receiving, at the access point, a probe request from the endpoint device, and wherein the wireless communication from the access point to the endpoint device comprises a probe response to the endpoint device.

7. A method for providing cached available service information from an access point for a wireless network to an endpoint device, the method comprising:
receiving available service information from an advertisement server;
caching, by the access point, the available service information received from the advertisement server, wherein the cached available service information comprises a list of one or more services available on the wireless network; and
providing, by the access point, at least a portion of the cached available service information to the endpoint device prior to an establishment by the access point of a wireless connection of the endpoint device to the wireless network.

8. The method of claim 7, wherein the step of caching further comprises periodically refreshing the cached available service information.

9. The method of claim 7, wherein the step of caching further comprises determining the cached available service information over a predetermined time period.

10. The method of claim 7, further comprising wirelessly receiving, in the access point, a plurality of Generic Advertisement Service (GAS) requests from the endpoint device;
wherein the step of providing further comprises wirelessly sending, by the access point, a plurality of GAS responses to the endpoint device, responsive to the plurality of GAS requests.

11. The method of claim 10, wherein the step of caching further comprises:
sending, by the access point, a plurality of query requests to the advertisement server;
receiving, by the access point, a plurality of query responses from the advertisement server, responsive to the plurality of query requests; and
caching the available service information based on the plurality of query responses.

12. The method of claim 11, further comprising:
in the access point, using Access Network Query Protocol (ANQP) to wirelessly receive the GAS requests and for the wirelessly sending the GAS responses, wherein the GAS requests and the GAS responses each comprise at least one ANQP element; and
in the access point, using ANQP for the sending of the query requests and for the receiving of the query responses, wherein the query requests and the query responses each comprise at least one ANQP element.

13. The method of claim 7, further comprising providing network optimization by using the cached available service information to reduce a number of query requests and query responses exchanged between the access point and the advertisement server.

14. The method of claim 7, the providing further comprising wirelessly sending, by the access point, a Generic Advertisement Service (GAS) response to the endpoint device comprising at least a portion of the cached available service information.

15. The method of claim 14, the method further comprising wirelessly receiving, in the access point, a GAS request from the endpoint device, wherein the step of wirelessly sending further comprises wirelessly sending, by the access point, the GAS response to the endpoint device responsively to the GAS request, the GAS response comprising at least a responsive portion of the cached available service information.

16. The method of claim 14, the method further comprising using Access Network Query Protocol (ANQP), in the access point, for the wirelessly receiving the GAS request and for the wirelessly sending the GAS response, and wherein the GAS response comprises an ANQP element requested by the endpoint device in the GAS request.

17. A method for discovering available service information in an endpoint device configured to be communicatively coupled to a wireless network via an access point of the wireless network, the method comprising:
detecting, by the endpoint device, the access point of the wireless network;
wirelessly receiving, in the endpoint device, a vendor specific information element from the access point prior to an establishment of a wireless connection of the endpoint device to the wireless network via the access point; and
determining available service information, by the endpoint device, using the vendor specific information element received from the access point prior to the establishment of the wireless connection of the endpoint device to the wireless network via the access point, wherein the available service information comprises a list of one or more services available on the wireless network.

18. The method of claim 17, wherein receiving the vendor specific information element further comprises wirelessly receiving, in the endpoint device, a beacon from the access point comprising the vendor specific information element, wherein the vendor specific information element comprises the available service information.

19. The method of claim 17, further comprising wirelessly sending, by the endpoint device, a probe request to the access point.

20. The method of claim 19, further comprising wirelessly receiving, in the endpoint device, a probe response from the access point, wherein the probe response is responsive to the probe request sent to the access point, and wherein the probe response comprises the vendor specific information element for determining the available service information provided in response to the probe request.
